(19) United States
(12) Patent Application Publication
(10) Pub. No.: US 2024/0054500 A1
(43) Pub. Date: Feb. 15, 2024

(54) SYSTEM AND METHOD FOR PROVIDING REAL-TIME TECHNICAL TROUBLESHOOTING SUPPORT

(71) Applicant: Calvin Mills, JR., Baton Rouge, LA (US)

(72) Inventor: Calvin Mills, JR., Baton Rouge, LA (US)

(21) Appl. No.: 17/884,509

(22) Filed: Aug. 9, 2022

(51) Int. Cl. G06Q 30/016

(52) U.S. Cl. CPC G06Q 30/016

(57) ABSTRACT

Provided a system and method of online and on-location technical troubleshooting support to resolve technical issues encountered by users of the electronic and digital devices. The system and method comprise a dual-sided platform in the form of a web-based platform and/or a mobile-based platform for people who need technical support and the people who provide technical support. The present invention introduces a novel system and method for personal digital devices having a program and circuitry for the real-time interaction between the customer and the technician, wherein the technician assists the customer online and/or on-location with troubleshooting, installation, set up, repair, continuous monitoring, vulnerability and compliance scanning etc.

### BACKGROUND OF THE INVENTION

### Field of Invention

The system and method of the present invention relates generally to a field of online as well as on-location assistance technology and related business platforms. More particularly, the present invention relates to the system and method of providing online and on-location technical troubleshooting support to a person who encounters technical issues associated with electronic or digital devices and needs technical support to resolve them.

### Description of Related Art

A wide range of interactive systems and methods is available for users of computer and/or computing device, wherein the users and the computer exchange information frequently and dynamically. The interactive systems either comprise of software and/or hardware systems. The software interactive systems ordinarily require standard input formats, such as keyboards and a mouse, and utilize these forms of input in ways that enhance the interactive nature of the software which further develop a more fascinating user experience. The hardware interactive systems often employ different input formats to create a system that can be more deeply interacted with by the user. These systems can utilize hardware such as touch-sensitive monitors and motion sensor devices.

To provide some context, several conventional systems and methods have been introduced to provide on-location troubleshooting services. Likewise, a prior art U.S. Pat. No. 8,429,088B2 to Scott et al. has been disclosed which describes about method and system for providing on-location troubleshooting services to homeowners and businesses for low-voltage electronic equipment and other on-location services. It employs the use of an Internet-based system for recording customer requests for service and subsequently automatically dispatching technicians and managing provision of the requested services.

However, the existing strategies encounter various drawbacks and do not provide desirable system or method for a smooth customer-business interactive communication to resolve the technical issues either online or on-location or both. Hence, there exists an utmost need of providing more optimal solution in order to have smooth, improved and fruitful customer-business interaction, both online and on-location, thereby to fix the technical issues anytime.

Therefore, the present invention discloses a system and method to provide on-demand consumer tailored IT solutions based on unique algorithms that support a business process from an initial customer interaction through archiving of the interaction. The algorithms will be the base information in training another environment/ecosystem-based AI that looks at whole solutions where the base of all data analytics will be housed across all initiatives fulfilled by the system and method of the present invention.

### SUMMARY OF THE INVENTION

The primary object of the present invention is to overcome the shortcomings associated with traditional technical troubleshooting systems by providing a network-based system and method for real-time technical troubleshooting support that allows a customer to connect with a technician in real-time, wherein the technician assists the customer online and/or on-location to resolve technical issues associated with the customer's electronic or digital devices.

Accordingly, the inventor has conceived and reduced to practice, in preferred embodiments of the present invention, the network-based system and method for real-time technical troubleshooting support which comprise a two-sided platform in the form of a web-based platform and/or a mobile-based platform for people who need technical support and the people who provide technical support. The present invention introduces a novel system and method for personal digital devices having a program and circuitry for the real-time interaction between the customer and the technician, wherein the technician assists the customer online and/or on-location with troubleshooting, installation, set up, repair, continuous monitoring, vulnerability and compliance scanning, etc. The system of the present invention comprises the web-based platform and/or the mobile-based platform accessible via a communication network and run by the personal digital device including, but not limited to, smartphones, computers, wearable devices, tablets, i-Pads, or other mobile computing devices.

According to an embodiment of the present invention, the system includes a plurality of user devices configured for one or more predefined categories of user and associated factors. The plurality of user devices may be communicably coupled with the communication network for accessing the web-based platform and/or the mobile-based platform installed on the plurality of user devices. The system also includes a virtual server communicably linked via the communication network with the plurality of user devices. The virtual server is configured to identify and store a unique user ID of the plurality of user devices via an identity generating module in communication with a processor associated with the virtual server in the communication network. The identity generating module is configured to store one or more predefined categories of the user and the associated factors on the virtual server. The identity generating module is configured to receive, via the plurality of user devices, metadata with respect to a plurality of user profiles with the one or more predefined categories of the user, wherein the metadata corresponds to the unique user ID. The identity generating module is configured to display the metadata for the plurality of user profiles and associated factors on the respective user devices.

According to an embodiment of the present invention, the method includes steps of: deploying the virtual server which is communicably linked with the plurality of user devices via the communication network, wherein the virtual server hosts a system software developed using system programming methodologies and systems programming languages, and designed specifically to execute a program for the mobile-based platform and/or the web-based platform to perform an interactive communication therebetween the plurality of user devices; configuring the plurality of user devices with the communication network for accessing the mobile-based platform and/or the web-based platform; identifying & storing the unique user ID of the plurality of user devices via the identity generating module in communication with the processor associated with the virtual server in the communication network; receiving the metadata with respect to the plurality of user profiles via the plurality of user devices, wherein the metadata corresponds to the unique user ID and the associated factors; and displaying the metadata and the associated factors on the respective user devices thereby to execute the customer-business interaction.

In one embodiment of the present invention, the plurality of user devices may comprise at least one customer device, at least one technician device, at least one business device, at least one admin device, and/or any combination thereof.

In one embodiment of the present invention, the plurality of user profiles with the one or more predefined categories of the users includes at least one of: a customer profile, a technician profile, a business profile, an admin profile, and/or any combination thereof.

In one embodiment of the present invention, the factors associated with the one or more categories of the users comprise sign up factor, sign/log in factor, and/or any combination thereof.

In one embodiment of the present invention, the technical issues may be referred as “tickets” with respective “ticket numbers”.

In one embodiment of the present invention, the customer profile posts at least one ticket on the web-based platform and/or the mobile-based platform via the customer device based on the technical issues being encountered including, but not limited to, troubleshooting, installation, set up, repair, continuous monitoring, vulnerability and compliance scanning, and/or any combination thereof.

In one embodiment of the present invention, one or more tickets being displayed on the web-based platform or the mobile-based platform of the technician or business device allowing the technician or business profile to respond to the one or more tickets.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram of a real-time technical troubleshooting support system for an interactive communication between a plurality of user devices in order to resolve technical issues, according to an embodiment of the present invention disclosed herein.

FIG. 1B illustrates a block diagram of elements of a processor disposed in a real-time technical troubleshooting support system, according to an embodiment of the present invention disclosed herein.

FIG. 2 illustrates a flowchart of a method for engaging a plurality of user devices for an interactive communication in order to resolve technical issues, according to an embodiment of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, wherever possible, to designate like elements common to the figures. Optional portions of the figures may be illustrated using dashed or dotted lines, unless the context of usage indicates otherwise.

### DETAILED DESCRIPTION OF THE INVENTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

Terms such as ‘connect’, ‘integrate’, ‘configure’, and other similar terms may include a physical connection, a wireless connection, a logical connection or a combination of such connections including electrical, optical, RF, infrared, or other transmission media, and include configuration of software applications to execute computer program instructions, as specific to the presently disclosed embodiments, or as may be obvious to a person skilled in the art.

It is to be understood that the term “user” and “user profile” are interchangeable, unless otherwise specified.

It is to be understood that the term “user” or “user profile” hereinafter refers to any or all of “customer or customer profile”, “technician or technician profile”, “business or business profile”, and “admin or admin profile”, unless otherwise specified.

It is to be understood that the term “customer” and “customer profile” are interchangeable, unless otherwise specified.

It is to be understood that the term “technician” and “technician profile” are interchangeable, unless otherwise specified.

It is to be understood that the term “business” and “business profile” are interchangeable, unless otherwise specified.

It is to be understood that the term “admin” and “admin profile” are interchangeable, unless otherwise specified.

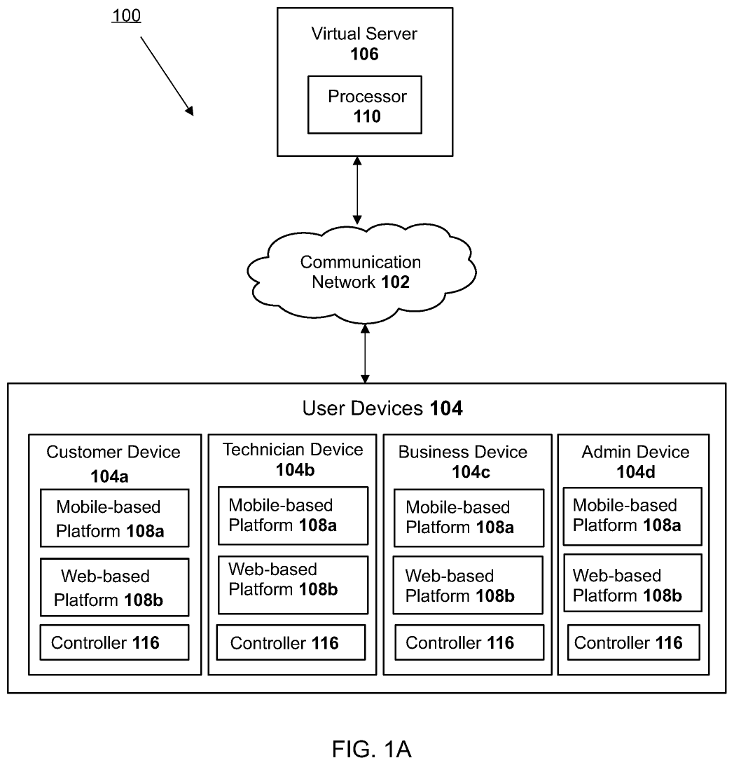

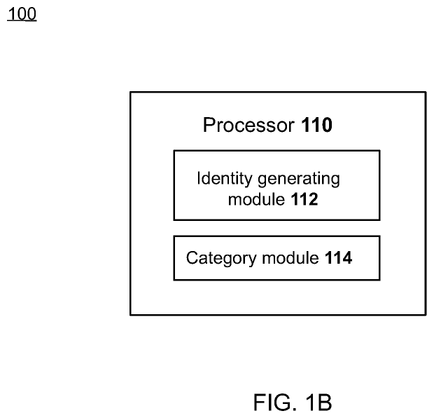

FIG. 1A illustrates a block diagram of a real-time technical troubleshooting support system 100 for an interactive communication between a plurality of user devices 104 in order to resolve technical issues, according to an exemplary embodiment of the present invention. The system 100 comprises a communication network 102, the plurality of user devices 104, and a virtual server 106. Further, the plurality of user devices 104 and the virtual server 106 may be connected via the communication network 102, according to an embodiment of the present invention. Furthermore, the plurality of user devices 104 is categorized into at least one customer device 104a accessed by at least one customer profile, at least one technician device 104b accessed by at least one technician profile, at least one business device 104c used by at least one business profile, and at least one admin device 104d utilized by at least one admin profile, according to an embodiment of the present invention.

The plurality of user devices 104 comprises a controller 116, wherein the controller 116 comprises a processing module and a storage device having a program stored in the storage device and operating on the processing module. The program is adapted to support the system 100 and method for managing the interactive communication between the plurality of user devices 104 and the virtual server 106.

According to one embodiment of the present invention, the communication network 102 may include a data network such as, but not limited to, a local area network (LAN), a wide area network (WAN), a metropolitan area network (MAN), a network enclave, intranet, internet, internet of things (IoT), a mesh network, a personal area network (PAN), a wireless local area network (WLAN), a campus area network (CAN), a storage area network (SAN), a passive optical local area network (POLAN), an enterprise private network (EPN), a virtual private network (VPN), a home area network (HAN), intelligent machines to include industrial robots, speech recognition/voice synthesis and self-guided vehicles, AI-to-AI communication and autonomous systems such as communication among self-driving vehicles and intelligent machines in factories, machine-to-machine communication, appliance to appliance communication, semantics-driven communication, cognitive communication, omnipresent and nonlimiting connectivity, flexible network topologies and deployments, distributed massive MIMO (multiple-input, multiple-output) solutions, communications over the terahertz frequency band (above 100 GHz) including terabit-per-second link capacities and miniature transceivers, distributed cloud infrastructure with integrated acceleration for data intensive virtual network functions and applications, serverless architectures, memory-centric computing, optical computing, nanocomputing, neuromorphic computing and quantum computing, infrastructure initiatives to include: automated trust assessment of all network elements, things, machines and applications, as well as compute and storage resources by using remote attestation and AI, and cognitive networks to include all variants of zero-touch network management and operations. The communication network 102 may include or otherwise cover networks or sub-networks, each of which may include, for example, a wired or a wireless data pathway.

According to one embodiment of the present invention, the plurality of user devices 104 of one or more categories of the user profiles are configured to access both a mobile-based platform 108a and a web-based platform 108ab.

In one embodiment of the present invention, the mobile-based platform 108a may be a mobile application that can be installed on the customer device 104a, the technician device 104b, the business device 104c, and the admin device 104d.

User Interface Walkthrough of the Customer Profile

The mobile-based platform 108a may be configured to display an introductory page when the customer profile visits the mobile-based platform 108a for the first time. The mobile-based platform 108a may display a plurality of options on a user interface of the customer device 104a. The plurality of options may comprise, “Log in” for an existing user, “Sign up” for a new user, and “Reset Password” for the existing user in case the existing user needs to change or reset his/her account password.

On tapping the “Sign up” option, the customer profile may be directed to select themself either as a customer or a certified IT technician. Once the customer profile selects themself as the customer, the customer profile is directed to sign up to the mobile-based platform 108a via the user interface of the customer device 104a, and be required to enter an email address which may already be registered with the mobile-based platform 108a.

In one embodiment of the present invention, after entering the email address, the mobile-based platform 108a may check if the email address is already associated with any existing business customers, and accordingly directs the customer towards further step.

After confirmation of the email address, the customer profile may receive a verification link on the registered email address which has to be followed by the customer profile via the customer device 104a in order to verify the authenticity of the registered email address.

Further, the customer profile is required to enter a valid phone number, which is then verified via a verification code sent on the provided phone number, wherein the customer profile is required to enter the verification code. In an exemplary scenario, if the customer profile fails to receive the verification code, then the customer profile can click on a “Resend code” button displayed on the customer device 104a.

After the phone number verification, the customer profile may proceed forward and fill out the required details of the signing up process for self-registration, wherein the customer profile may need to provide basic details, such as first name, last name, etc. When the basic details are filled up, the customer profile may login via the registered email address and password that has been used for the signing up process.

In a preferred embodiment of the present invention, the customer profile may encounter a navigation menu on the mobile-based platform 108a for the ease of operation. When the customer profile accesses the mobile-based platform 108a after signing in, the user interface of the customer device 104a displays a plurality of navigational icons at a bottom edge of the user interface, such as “HOME”, “MY TICKETS”, “MY ORG”, and “PROFILE”. Initially, the customer profile may be directed to a home page when signed up wherein the customer profile is provided with a list of tickets along with total number of respective tickets, such as “Opened Tickets (0-n number)”, “Closed Tickets (0-n number)”, and “New Tickets (0-n number)”.

Moreover, the mobile-based platform 108a provides on the home page of the customer device 104a, an option to create and post a new ticket by tapping on a “New Ticket” tab that directs the customer profile to create and post the new ticket concerning any technical issue encountered by them. In addition, the mobile-based platform 108a provides on the home page of the customer device 104a, a list of technician profiles working at nearby location of the customer profile. Moreover, each technician profile may indicate an active status in order to let the customer profile know about their availability.

According to an embodiment of the present invention, the customer profile may create and post the new ticket through the “New Ticket” tab. When the customer selects the “New Ticket” tab, the mobile-based platform 108a directs the customer to a new ticket page to create and post the new ticket, wherein the customer is required to provide a description of the technical issue and upload relevant file therewith. The relevant file may comprise, but not limited to, image file, video file, audio file, and any combination thereof.

Further, the mobile-based platform 108a provides on the new ticket page, a list of preferred technician profiles for the customer profile to select from them, wherein each preferred technician profile may indicate the active status in order to let the customer profile know about their availability.

Furthermore, the customer profile may select at least one preferred technician from the list of preferred technician profiles and proceed towards payment thereafter, wherein the customer profile may be required to select a payment method. In an exemplary scenario, if the customer profile has a coupon code to claim discount, then the customer profile may enter the coupon code before the payment. After the selection of the payment method and entering the coupon code, the customer profile may tap on “Submit Ticket” tab to post the new ticket.

In one embodiment of the present invention, the customer profile may be able to check status update of each ticket by tapping on the “MY TICKETS” icon which directs the customer profile to my tickets page, wherein the mobile-based platform 108a provides the customer profile with various options, such as “All”, “Open”, and “Close”. On tapping the “All” option, the customer profile may be able to access list of all the tickets including open, close, new, etc. By selecting any particular ticket, the customer profile may check the details related to the particular ticket, such as technical problem description, last activity from the customer/technician profile, relevant file attachments, and current status i.e., new, awaiting action, completed, canceled, etc.

According to an embodiment of the present invention, each ticket may be assigned a six-digit ticket number to maintain a unique identification.

In one embodiment of the present invention, the customer profile may filter the type of tickets by tapping on “Open” option to access the list of the opened tickets, and “Close” option to access the list of the closed tickets.

In one embodiment of the present invention, the my tickets page may also provide a search option on a top edge of the user interface where the customer profile may enter the six-digit ticket number to search for a particular ticket to get a quick access to the details of that ticket.

In one embodiment of the present invention, once the technical issue is fixed by the technician, the customer may be able to review their experience with the technician by proving suitable ratings and sharing feedback with the technician for their service and assistance, and close the ticket thereby. The customer may also skip to provide the ratings and feedback to the technician and directly close the ticket.

In one embodiment of the present invention, the customer profile may be able to review their organization data by tapping on the “MY ORG” icon which directs the customer profile to my org page, wherein the mobile-based platform 108a displays name of the organization on the top edge of the user interface, and provides the customer profile with various tabs thereto, such as “Tickets”, “Users”, and “Stats”. On tapping the Tickets tab, the customer may be able to access the list of all the tickets including open, close, new, etc. in similar manner as described earlier in the present disclosure.

On tapping the Users tab, the customer may be able to access a list of users associated with their organization. Each user may be listed with a picture, name, email address, phone number, etc.

According to an embodiment, the customer may be able to add a user by tapping on “Add User” tab provided at the bottom of the user interface of the customer device 104a.

On tapping the Stats tab, the customer may be able to access an overall statistic of “Ticket Resolution Trend”, and “Ticket Response Trend”, over an extensive period of time. Moreover, the customer profile may select a time range from “Last 7 Days”, “Last 14 Days”, “Last 21 Days”, “Last Month”, “Last 3 Months”, “Last 6 Months”, and “Last Year” to review the statistic of the selected time frame.

Further, the mobile-based platform 108a may keep track of the total number of tickets of all the time. The customer may be able to access the total number of tickets under “Total Tickets” tab displayed under the Stats tab, wherein the customer may be able check the count of tickets for “Present day”, “Present week”, “Last week”, “Present month”, “Last month”, “Present year”, and “All time”.

In another embodiment of the present invention, the customer profile may use the web-based platform 108b on a web browser of the customer device 104a.

User Interface Walkthrough of Individual Technician Profile OR Business Profile

The mobile-based platform 108a may be installed on the technician device 104b or the business device 104c which displays an introductory page when the technician/business profile visits the mobile-based platform 108a for the first time. The mobile-based platform 108a may display a plurality of options on a user interface of the technician device 104b or the business device 104c. The plurality of options may comprise, “Log in” for an existing user, “Sign up” for a new user, and “Reset Password” for the existing user in case the existing user needs to change or reset his/her account password.

In one embodiment of the present invention, the business profile may need to register their business with the mobile-based platform 108a and the web-based platform 108b, in order to access the service rendered via the mobile-based platform 108a and the web-based platform 108b, which is described in a greater detail in the following description.

On tapping the “Sign up” option, the technician/business profile may be directed to select themself either as a customer or a certified IT technician. Once the technician/business profile selects themself as the certified IT technician, the technician/business profile is directed to sign up to the mobile-based platform 108a via the user interface of the technician device 104b or the business device 104c, and be required to enter an email address which may already be registered with the mobile-based platform 108a.

In one embodiment of the present invention, after entering the email address, the mobile-based platform 108a may check if the email address is already associated with any existing business technicians, and accordingly directs the technician/business towards further step.

After confirmation of the email address, the technician/business profile may receive a verification link on the registered email address which has to be followed by the technician/business profile via the technician device 104b or business device 104c in order to verify the authenticity of the registered email address.

Further, the technician/business profile is required to enter a valid phone number, which is then verified via a verification code sent on the provided phone number, wherein the technician/business profile is required to enter the verification code. In an exemplary scenario, if the technician/business profile fails to receive the verification code, then the technician/business profile can click on a “Resend code” button displayed on the technician device 104b or business device 104c.

After the phone number verification, the technician/business profile may proceed further and fill up the required details of the signing up process for self-registration, wherein the technician/business profile may need to provide basic details, such as first name, last name, etc. When the basic details are filled up, the technician/business profile may login via the registered email address and password that has been used for the signing up process.

After the signing up process, the technician/business profile may login via the registered email address and the password that has been used to create the account. The technician/business profile after logging in to the mobile-based platform 108a, gets insight of an overview of their account that displays a plurality of navigational icons at a bottom edge of the user interface, such as “DASHBOARD”, “QUEUE”, “MY TICKETS”, “MY ORG”, and “PROFILE”. Initially, the technician/business profile may be directed to a dashboard page when signed up where the technician/business profile is provided with several features, such as tickets assigned to them under “My Tickets” tag that further classified based on current status, stats concerning ticket resolution trend, total tickets of their company under “Company” tag that further classified based on current status, and a list of technicians under “Staff” tag.

In one embodiment of the present invention, the current status includes, but not limited to, open tickets, close tickets, tickets with recent activity, tickets which are awaiting any action from the customer profile, etc.

In one embodiment of the present invention, each technician/business profile under the “Staff” tag may indicate an active status in order to let the technician/business profile know about their availability.

In one embodiment of the present invention, the technician/business profile may be able to check status update of each ticket by tapping on the “MY TICKETS” icon which directs the technician/business profile to my tickets page, wherein the mobile-based platform 108a provides the technician/business profile with various options, such as “All”, “Open”, and “Close”. On tapping the “All” option, the technician/business profile may be able to access list of all the tickets including open, close, new, etc. By selecting any particular ticket, the technician/business profile may check the details related to the particular ticket, such as technical problem description, last activity from the technician/business/customer profile, relevant file attachments, and current status i.e., new, awaiting action, completed, canceled, etc.

In one embodiment of the present invention, the technician/business profile may filter the type of tickets by tapping on “Open” option to access the list of the opened tickets, and “Close” option to access the list of the closed tickets.

In one embodiment of the present invention, the my tickets page may also provide a search option at a top of the user interface where the technician/business profile may search for a particular ticket to get a quick access to the details of that ticket.

In one embodiment of the present invention, the technician/business profile may be able to access a queue of new or upcoming tickets by tapping on the “QUEUE” icon, wherein the technician/business profile may review all the new tickets and may choose to assign any ticket to themselves or may choose to assign any ticket to other suitable technician from their company.

After assignment of the ticket, the technician/business profile may access the assigned ticket and review the technical issue cited under the assigned ticket. Based on the review, the technician/business profile may require to resolve the technical issue by proposing some troubleshooting tips and steps that does not require an additional service and can be resolved by the customer themself, merely by following the troubleshooting tips and steps provided by the technician/business profile. However, the customer may review the proposed resolution and may either accept or reject it.

Further, the technician/business profile may require to resolve the technical issue by proposing the additional service with quoted price if the technical issue necessitates to be resolved by the additional service, and that may require the technician/business on-location to get it fixed. Then, the customer profile may need to accept the proposed additional service in order to allow the technician/business to perform the fixing task at their location.

In one embodiment of the present invention, if customer profile accepts the proposed additional service and the proposed additional service requires the technician/business on-location to fix the issue, then the technician may be dispatched thereto at the location of the customer, hence to perform the fixing task on-location to resolve the technical troubleshooting issue.

In one embodiment of the present invention, the technician/business profile may be able to review their organization data by tapping on the “MY ORG” icon which directs the technician/business profile to my org page, wherein the mobile-based platform 108a displays name of the organization at the top edge of the user interface, and provides the technician/business profile with various tabs thereto, such as “Tickets”, “Techs”, and “Stats”. On tapping the “Tickets” tab, the technician/business may be able to access the list of all the tickets including open, close, new, etc. in similar manner as described under the “MY TICKETS” icon in the foregoing disclosure.

On tapping the “Techs” option, the technician/business may be able to access the list of technicians associated with their organization. Each technician may be listed with a picture, name, email address, phone number, etc.

According to an embodiment, the technician/business may be able to add a new technician by tapping on “Add Tech” button provided at the bottom of the user interface of the technician device 104b or business device 104c.

On tapping the “Stats” tab, the technician/business may be able to access an overall statistic of “Ticket Resolution Trend”, and “Ticket Response Trend”, over an extensive period of time. Moreover, the technician/business profile may select a time range from “Last 7 Days”, “Last 14 Days”, “Last 21 Days”, “Last Month”, “Last 3 Months”, “Last 6 Months”, and “Last Year” to review the statistic of the selected time frame.

Further, the mobile-based platform 108a keeps track of the total number of tickets of all time. The technician/business may be able to access the total number of tickets under “Total Tickets” tab displayed under the “Stats” tab, wherein the technician/business may be able check the count of tickets for “Present day”, “Present week”, “Last week”, “Present month”, “Last month”, “Present year”, and “All time”.

In another embodiment of the present invention, the technician/business profile may also use the web-based platform 108b through a web browser of the technician device 104b or business device 104c.

User Interface Walkthrough of Business Profile Registration

According to an embodiment of the present invention, the business profile may need to register their business through the web-based platform 108b. When the business profile accesses the web-based platform 108b, an introductory page may appear along with a tab of “SIGN UP” in order to create an account.

In one embodiment of the present invention, if the business profile has already signed up to create the account, then the business profile may simply access their account by logging in by tapping on “LOG IN” tab displayed on the user interface of the business device 104c, and get registered themself.

In another aspect, the business profile may tap on the “SIGN UP” tab to create the account, wherein the business profile may be directed to opt an account type from an ‘individual technician’, and an ‘organization’. On selecting the account type as the ‘organization’, the business profile may further be directed to enter the mandatory information related to their organization such as, but not limited to, organization name, first name, last name, email ID, address, etc. After providing the mandatory information, the business profile may proceed further to create the account, and henceforward proceed towards exploring all the services rendered by the mobile-based platform 108a and/or the web-based platform 108b.

Admin Profile Overview

The admin profile may log in to the mobile-based platform 108a and/or the web-based platform 108b, and oversee all the latest updates that are happening across the mobile-based platform 108a and/or the web-based platform 108b. Moreover, the total number of the user profiles that have signed up to the mobile-based platform 108a and/or the web-based platform 108b may be shown to the admin profile.

The admin profile may be able to manage all the user profiles. The admin profile may be able to see total number of new users signed up for a current month and so forth.

Data Storing and Data Processing for a Real-Time Technical Troubleshooting Support

According to an embodiment of the present invention, the virtual server 106 may be configured to receive data associated with the at least one user, when the registration of the at least one user is completed. The virtual server 106 may include a dedicated space to accommodate a plurality of computer systems, storage devices, servers, routers, network switches and other associated devices or components that are necessary in the processes of a typical telecommunication network, such as transportation of network data traffic from a virtual server to the consumer premise equipment.

The virtual server 106 may be configured to provide a dynamic storage management for data storage. The virtual server 106 may further comprise a processor 110 configured to process various data and information.

According to an embodiment of the present invention, the virtual server 106 hosts a system software developed using system programming methodologies and systems programming languages, and designed specifically to execute a program for the mobile-based platform 108a and/or the web-based platform 108b to perform the interactive communication therebetween the plurality of user devices 104.

According to an embodiment of the present invention, the processor 110 may be configured on the virtual server 106 for processing data. The term processor 110 may refer to one or more individual processors, processing devices and various elements associated with a processing device that may be shared by other processing devices.

Additionally, the one or more individual processors, processing devices and elements are arranged in various architectures for responding to and processing the instructions that drive the aforesaid system.

FIG. 1B illustrates a block diagram of elements of the processor 110, according to an embodiment of the present invention. The processor 110 may comprise an identity generating module 112, a category module 114, and so forth.

The processor 110 may be configured on the virtual server 106 for processing data associated with the real-time technical troubleshooting support system 100. The processor 110 is configured to identify a unique user ID with respect to the user on the user device 104 through the identity generating module 112 in communication with the processor 110 associated with the virtual server 106 in the communication network 102.

Further, the processor 110 may be configured to receive, transmit and process data associated with the real-time technical troubleshooting support system 100, in an embodiment of the present invention. The processor 110 may be, but not limited to, a programmable logic control unit (PLC), a microcontroller, a microprocessor, a computing device, and so forth.

In an embodiment of the present invention, the processor 110 may be configured to communicate with the customer device 104a, the technician device 104b, the business device 104c, and the admin device 104d.

In an embodiment of the present invention, the category module 114 may be configured to provide various predefined categories and factors based on which the system 100 determines and aggregates various metadata to be assigned to respective users. The one or more categories may comprise at least one from the customer profile, the technician profile, the business profile, and the admin profile. The factors associated with the one or more categories comprises sign up factor, sign/log in factor, and so forth.

In an exemplary scenario, if the category module 114 determines that the category is the customer profile, then the customer device 104a may display the metadata associated with the customer profile comprising a list of all the tickets along with current status, post a new ticket, view ticket details, a list of technicians working nearby, accept or reject the proposed service, rate the technician, view profile, and so forth.

In another exemplary scenario, if the category module 114 determines that the category is the technician profile or the business profile, then the technician device 104b or the business device 104c may display the metadata associated with the technician profile or the business profile comprising: a list of all the tickets along with current status, view tickets that are assigned to anyone, view tickets that are assigned to the technician profile or the business profile, approve or claim a ticket, assign ticket to other technician, reject ticket, propose a resolution, submit resolution and close the ticket, view profile, and so forth.

In further exemplary scenario, if the category module 114 determines that the category is the admin profile, then the admin device 104d may display the metadata associated with the admin profile comprising overview option, and so forth.

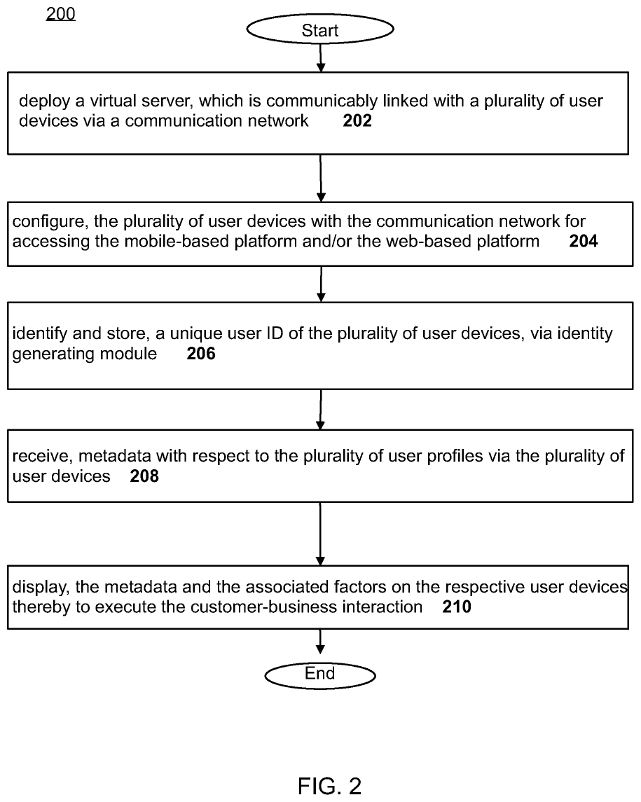

FIG. 2 illustrates a flowchart demonstrating a method for engaging a plurality of user profiles for the real-time technical troubleshooting support, according to an embodiment of the present invention.

At step 202, the system 100 may deploy the virtual server 106 which is communicably linked with the plurality of user devices 104 via the communication network 102, wherein the virtual server 106 may host the system software developed using the system programming methodologies and the system programming languages, and designed specifically to execute the program for the mobile-based platform 108a and/or the web-based platform 108b to perform the interactive communication therebetween the plurality of user devices 104.

At step 204, the plurality of user devices 104 may configure with the communication network 102 for accessing the mobile-based platform 108a and/or the web-based platform 108b.

Further at step 206, the identity generating module 112 may identify and store the unique user ID of the plurality of user devices 104, wherein the identity generating module 112 may be in communication with the processor 110 associated with the virtual server 106 in the communication network 102.

At step 208, the system 100 may receive the metadata with respect to the plurality of user profiles via the plurality of user devices 104, wherein the metadata corresponds to the unique user ID and the associated factors.

Finally at step 210, the system 100 displays the metadata and the associated factors on the respective user devices thereby to execute the customer-business interaction.

The system and method of the present invention is highly beneficial to render the service of resolving technical troubleshooting issues experienced by a wide range of population all around the world on day-to-day basis. The system of present invention has defined various algorithms that manage system's internal tracking, assignment of additional tasks, distribution of workload, and analysis of the business processes for efficiency improvements. Further, embedded AI and machine learning are leveraged for Business to Business, Business to Government (local, state, federal, international), Business to Consumer, IaaS, SaaS, IAM, Cybersecurity & Monitoring, Health Informatics, Bioinformatics, Quantum Computing, Facilities/Property Management (BMS), Business to Fleet (Telematics), and Agri-business processing in addition to highly automated Customer interaction. Moreover, the data analytics power the business intelligence algorithm to develop enhanced customer engagement, mobile optimization, and improved response from business partners and consumers. Most importantly, the present invention described herein aims to provide a solution that is practical, that can be implemented into a viable commercial success.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

1. A real-time technical troubleshooting support system to provide online and on-location technical assistance to resolve technical issues associated with electronic or digital devices, said system comprising:
a communication network, said communication network is disposed to access a mobile-based platform and/or a web-based platform via a plurality of user devices;
the plurality of user devices associated with a plurality of user profiles, wherein the plurality of user devices is communicably linked with said communication network; and
a virtual server, said virtual server is communicably linked with the plurality of user devices via said communication network, wherein said virtual server is configured to identify a unique user ID of the plurality of user devices, wherein said virtual server hosts a system software which is developed using system programming methodologies and systems programming languages, and designed specifically to execute a program for said mobile-based platform and/or said web-based platform to perform an interactive communication therebetween the plurality of user devices.

2. The system of claim 1, wherein the plurality of user devices comprises two or more of the following: at least one customer device, at least one technician device, at least one business device, and at least one admin device.

3. The system of claim 1, wherein the plurality of user profiles comprises two or more of the following: at least one customer profile, at least one technician profile, at least one business profile, and at least one admin profile.

4. The system of claim 1 wherein the plurality of user profiles includes at least one customer profile and, wherein the plurality of user devices includes at least one customer device and, wherein the at least one customer profile may post a ticket concerning technical issue on said mobile-based platform or said web-based platform via the at least one customer device.

5. The system of claim 4, wherein said technical issue may be related to, but not limited to, troubleshooting, installation, set up, repair, continuous monitoring, vulnerability and compliance scanning, and/or any combination thereof.

6. The system according to claim 1 wherein the plurality of user profiles includes at least one technician profile or at least one business profile and, wherein the plurality of user devices includes at least one technician device or at least one business device and, wherein the at least one technician profile or business profile may respond to said ticket from said mobile-based platform or said web-based platform via the at least one technician device or business device.

7. The system according to am claim 6, wherein the at least one technician profile or at least one business profile may resolve said ticket by proposing online resolution tips.

8. The system according to claim 6 further comprising at least one customer profile, wherein the at least one technician profile or business profile may resolve said ticket by proposing an additional service that may require the at least one technician profile or business profile to be dispatched thereto at location of the at least one customer profile.

9. The system according to claim 6, wherein the at least one customer profile may accept or reject the resolution proposed by the at least one technician profile or business profile.

10. The system of claim 1, wherein the virtual server may be configured to provide a dynamic storage management for data storage.

11. The system of claim 1, wherein the virtual server may comprise a processor configured to process various data and information.

12. The system of claim 11, wherein the processor may comprise an identity generating module to identify a unique user ID with respect to the user of the plurality of user devices.

13. The system of claim 11, wherein the processor may be configured to communicate with a customer device, a technician device, a business device, and an admin device.

14. The system of claim 11, wherein the processor may comprise a category module to provide various predefined categories and factors based on which the system determines and aggregates various metadata to be assigned to respective users.

15. A method for providing a real-time technical troubleshooting support to resolve technical issues associated with electronic or digital devices, said method comprising:
deploying a virtual server, wherein said virtual server is communicably linked with a plurality of user devices via a communication network, wherein said virtual server hosts a system software developed using system programming methodologies and systems programming languages, and designed specifically to execute a program for a mobile-based platform and/or a web-based platform to perform an interactive communication there between the plurality of user devices;
configuring the plurality of user devices with said communication network for accessing said mobile-based platform and/or said web-based platform;
identifying & storing a unique user ID of the plurality of user devices via an identity information generating module in communication with a processing component associated with said virtual server in said communication network;
receiving metadata with respect to a plurality of user profiles via the plurality of user devices, wherein the metadata corresponds to said unique user ID and associated factors; and
displaying the metadata and the and associated factors on the respective user devices.

16. The method of claim 15, wherein the plurality of user devices are selected from the group consisting of: a customer device, a technician device, a business device, a admin device, and any combination thereof.

17. The method of claim 15, wherein the plurality of user profiles are selected from the group consisting of: a customer profile, a technician profile, a business profile, a admin profile, and any combination thereof.

18. The method of claim 15, wherein the associated factors may comprise: sign up factor, sign in factor, and/or any combination thereof.

19. The method of claim 17, wherein the metadata associated with the at least one customer profile comprises one or more of the following: a list of tickets and current status, post a new ticket, view ticket details, a list of technicians working nearby, accept or reject the proposed service, rate the technician, and view profile.

20. The method of claim 17, wherein the metadata associated with at least one technician profile or business profile comprises one or more of the following: a list of all the tickets along with current status, view tickets that are assigned to anyone, view tickets that are assigned to the technician profile or the business profile, approve or claim a ticket, assign ticket to other technician, reject ticket, propose a resolution, submit resolution and close the ticket, view profile, and so forth.

21. (canceled)
